(19) United States
(12) Patent Application Publication
(10) Pub. No.: US 2016/0116719 A1
(43) Pub. Date: Apr. 28, 2016

(54) Compact multispectral wide angle refractive optical system

(71) Applicant: Qioptiq Limited, St. Asaph (GB)

(72) Inventor: Nicholas Allan Thompson, St. Asaph (GB)

(21) Appl. No.: 14/883,716

(22) Filed: Oct. 15, 2015

(30) Foreign Application Priority Data
Oct. 27, 2014 (GB) 1419103.5

(51) Int. Cl. G02B 13/14; G02B 7/02; G02B 1/02; G02B 13/18; G02B 9/12

(52) U.S. Cl. CPC G02B 13/146; G02B 13/18; G02B 9/12; G02B 1/02; G02B 7/021

(57) ABSTRACT

A multispectral wide angle refractive optical device for focusing light from a first waveband and a non-overlapping second waveband is presented. A first element formed of a first material receives incident radiation. A second element formed of diamond material receives radiation from the egress end of the first element. A third element formed of a third material receives radiation from the egress end of the second element. An optical train through the three elements onto a common focal plane is shared by the first waveband and a second waveband.

### CROSS-REFERENCE TO RELATED APPLICATION

This application claims the benefit of a United Kingdom Patent Application entitled “Compact multispectral wide angle refractive optical system” the specification of which was filed on Oct. 27, 2014 and given serial number 1419103.5, which is incorporated by reference herein in its entirety.

### FIELD OF THE INVENTION

The present invention relates to optics, and more particularly, is related to short wavelength and long wavelength infrared optics.

### BACKGROUND OF THE INVENTION

A multi spectral system may be used to detect electromagnetic radiation across two portions of the spectrum. The short wave infrared (SWIR) spectrum extends between approximately 0.9 μm and 1.7 μm. The long wave infrared (LWIR) spectrum extends between approximately 8 μm and 12.0 μm.

A SWIR scene is intuitive to a human user, being predominately reflected radiation and therefore similar to a black and white visible scene. However, since SWIR is longer in wavelength than visible light, it is capable of propagating further than visible light through the atmosphere relatively scatter free. It is also possible for SWIR wavelengths to pass through smoke and haze to a greater extent than visible wavelengths.

A LWIR scene is predominantly self-emissive and is therefore ideal for detecting thermal signatures within a scene. The functionality of such systems is not affected by being in complete darkness. The nature of self-emissive imagery can make it harder to interpret by the human user.

By combining these two wavebands, it is possible to achieve visible type imagery that is less obscured by real-world conditions, for example, battle obscurants and haze in which thermal signatures are highlighted. In previous multispectral systems the detection of SWIR and LWIR wavebands has been achieved using separate optical trains, where each optical train focuses a single waveband onto a separate focal plane. The signals are then overlaid before presentation to the user. One area in which multispectral detection is of particular interest is in helmet mounted goggle systems. Two critical parameters in helmet mounted systems are the mass and the size of the systems.

One way to achieve achromatic correction across the two wavebands is to use a purely reflective design. However, because goggle systems require large fields of view (typically around 40° or greater) and very fast f-numbers (typically around f/1.2 or less) it is unlikely that a purely reflective design satisfying these parameters will be compact enough for some applications. Therefore, there is a need in the industry to overcome one or more of the abovementioned shortcomings.

### SUMMARY OF THE INVENTION

Embodiments of the present invention provide a compact multispectral wide angle refractive optical system. Briefly described, the present invention is directed to a multispectral wide angle refractive optical device for focusing light from a first waveband and a non-overlapping second waveband. A first element formed of a first material receives incident radiation. A second element formed of diamond material receives radiation from the egress end of the first element. A third element formed of a third material receives radiation from the egress end of the second element. An optical train including the three elements is shared by the first waveband and a second waveband to a common focal plane.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIG. 1 is a simplified schematic diagram of a refractive multispectral wide angle refractive optical device.

FIG. 2 is a schematic diagram of a first embodiment refractive multispectral wide angle optical device.

FIG. 3 is a schematic diagram of a second embodiment refractive multispectral wide angle optical device.

FIG. 4A is a partial dispersion plot for the LWIR highlighting areas having candidates for materials 1 and .

FIG. 4B is a partial dispersion plot for the SWIR highlighting areas having candidates for materials 1 and 3.

FIG. 5 is a cutaway schematic diagram of an exemplary optical device in a housing.

FIG. 6 is a flowchart of an exemplary method for forming a multispectral wide angle refractive optical device.

### DETAILED DESCRIPTION

The following definitions are useful for interpreting terms applied to features of the embodiments disclosed herein, and are meant to define elements within the disclosure. As used within this disclosure, “wide angle” generally refers to a field of view of 30 degrees or more, preferably 40 degrees or more.

As used within this disclosure, very fast f-numbers refer to f-numbers of f/1.3 or faster, for example, f/1.2, f/1.1, f/1.0, or faster.

As used within this disclosure, “optics” refers to one or more elements configured to convey and/or process radiation, both within and beyond the visible spectrum. Such processing may include, but is not limited to, reflection, focusing, diversion, filtering, refraction, dispersion, and other processing of radiation.

As used within this disclosure, a “stop” refers to the aperture size of an optical system, controlling the beam width which the system can pass and is corrected for.

As used within this disclosure, “thin lenses” refers to lenses with zero center thickness, for example, located at the limiting aperture (stop) of the system. This mathematical simplification reduces the problem such that the aberrations become easier to analyze, and holds true to the first order so that the basic principles can be conveyed.

As used within this disclosure, a “planar” surface may be thought of as a spherical surface with a substantially infinite radius of curvature.

As used within this disclosure, “aspherical” refers to a surface profile, for example a lens profile, that is not a portion of a sphere or cylinder.

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention provide a wide angle objective lens having a single optical train for detecting both SWIR and LWIR wavebands. These embodiments provide a material combination to achieve a compact refractive solution to the aforementioned challenges. The layout may be thought of in terms of thin lenses in contact at the stop. The chromatic properties of a first material and a second material combine to form an imaginary material with dispersion characteristics which complement a third material. The use of diamond as the second (central) material in a three material design allows the user to achieve a very well corrected, fast, compact, wide angle system.

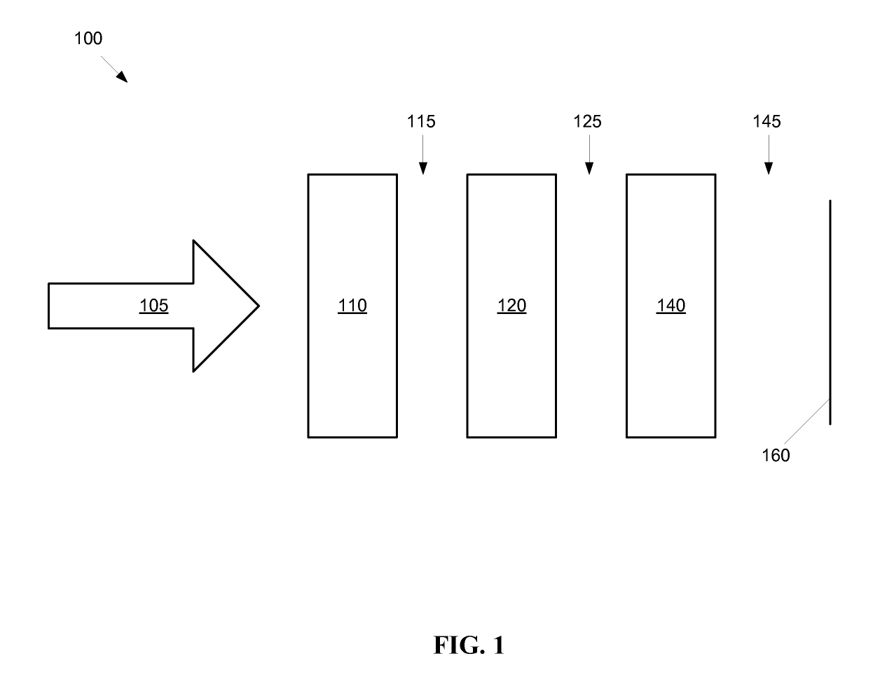

FIG. 1 is a schematic diagram showing a simplified form of a first embodiment 100 of the current invention. Incident radiation 105 passes through a first element 110 formed of a first material, a second element 120 formed of a second material, and a third element 140 formed of a third material. The materials of the first, second and third elements 110, 120, 140 are chosen such that the elements 110, 120, 140 combine to focus the incident radiation 150 upon a focal plane 160. There may be a first gap 115 between the first element 110 and the second element 120, and/or a second gap 125 between the second element 120 and the third element 140. The focal plane 160 may be spaced apart from the third element 140 by a third gap 145.

The materials and optical design for the elements 110, 120, 140 are considered to provide SWIR/LWIR common aperture and common focal plane imaging systems. Other considerations include system survivability in harsh environments. The f-number of each example system may be reduced as much as possible while maintaining what is considered a sensible solution for manufacturing purposes.

In general, the smaller the f-number is, the “faster” the system is. Therefore, a system having a smaller f-number allows more light (via a larger aperture) into the system than a system having a larger f-number. Decreasing the f-number is desirable in some respects. For example, detection range increases, while NETD (Noise Equivalent Temperature Difference) of the system decreases. However decreasing the f-number of the system also imparts several difficulties. For example, the size of the elements increases in diameter and likely in center thickness to achieve a reasonable edge thickness, resulting in likely increases in the cost of the system. Further, both chromatic and non-chromatic aberrations become harder to control, possibly introducing further complexity to the system. In addition, the sensitivity of the system to manufacturing tolerances will generally increase.

As noted above, the optical layout consists of three materials. The first element 110 and the third element 140 are each dual aspheric. The material for the second element 120 is diamond. As described further below, the second element 120 may be a combination of two or more sub-elements, for example, to simplify manufacturing and reduce costs. The material of the second (central) element 120 (diamond) acts as the main positive optical power contributor to the system 100.

As previously stated, the chromatic properties of two of the materials in the system combine to form an imaginary material with chromatic properties which complement the third. It is desirable that the materials for the first element 110 and third element 140 lend themselves to the manufacture of aspheres. By making these external components aspheric, the correction of non-chromatic aberration is possible, allowing the f-number of the system to be reduced while maintaining a small form factor, for example, comparable in size and shape to existing single band solutions.

As noted above, the material for the second element 120 is generally diamond. In contrast, the choice of materials for the first element 110 and the third element 140 may be relatively relaxed. To demonstrate this, a multispectral Abbe number, V, is defined using the two extreme wavelengths (λₘᵢₙ and λₘₐₓ) and the refractive index of the material at these wavelengths (n_{λ,min}, n_{λ,max}). λₘᵢₙ represents the lowest wavelength of interest, in this case, the bottom of the SWIR band, and λₘₐₓ represents the highest wavelength of interest, in this case, the top of the LWIR band. The central wavelength, λₘᵢₙ, represents the harmonic mean of the wavelengths between the wavebands of interest. V is determined by

$$V = ( \frac{{n}_{λ , mid} - 1}{{n}_{λ , min} - {n}_{λ , max}} ) . \qquad ( Eq . 1 )$$

In order to evaluate the color correction of a system, a partial dispersion, Pₐ, of the material is defined from λₘᵢₙ. The partial dispersion between the wavelengths λₘᵢₙ and λ is determined by

$${P}_{λ} = ( \frac{{n}_{λ , min} - {n}_{λ}}{{n}_{λ , min} - {n}_{λ , max}} ) . \qquad ( Eq . 2 )$$

For the SWIR and LWIR wavebands, this means that

| | | |
|---|---|---|
| λₘᵢₙ = 0.9 μm | λₘₐₓ = 12.0 μm | λ_{mid} = 2.8 μm |

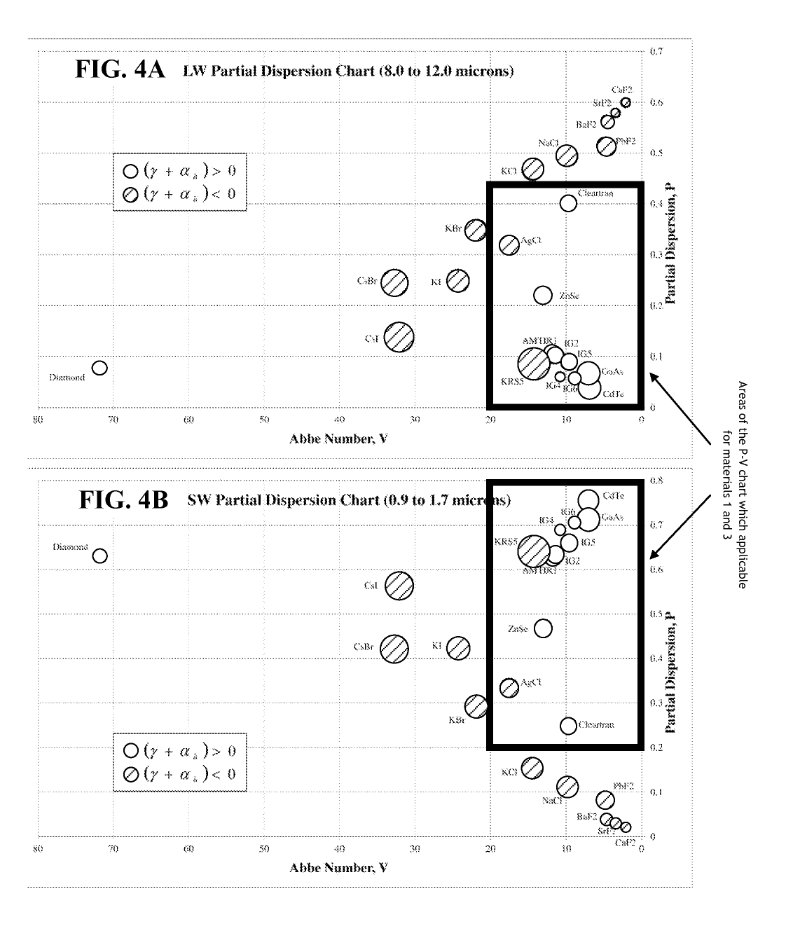

As shown in FIGS. 4A and 4B, Eq. 1 and Eq. 2 may be used to form partial dispersion plots for the LWIR waveband (FIG. 4A) and SWIR waveband (FIG. 4B) by taking λ to be the edge of the waveband in question closest to λ_{mid}. For each plot, the region in which materials would fall if they would be applicable for use as either material for the first element 110 (FIG. 1) or material for the third element 140 (FIG. 1) is indicated by a dark lined rectangle. The SWIR and the LWIR are the two wavebands which have been targeted in the design. These wavebands are not contiguous, the longest wavelength of the SWIR being around 1.7 microns and the shortest wavelength of the LWIR being around 8 microns. In FIGS. 4A and 4B αₕ indicates the coefficient of thermal expansion of a material housing the elements 110, 120, 140 (FIG. 1), while γ is the thermal glass coefficient.

Further details on the theory may be found in the June 2013 Optical Engineering paper by Nicholas Allan Thompson, entitled “Optical design of common aperture, common focal plane, multispectral optics for military applications,” which is hereby incorporated by reference in its entirety. This paper deals with the general theory for material selection and examples are given for narrow angle solutions. In contrast, the embodiments discussed herein refer specifically to wide angle solutions.

Having a wide range of materials available to choose from for the first element 110 (FIG. 1) and the third element 140 (FIG. 1) allows the designer of an optical device to use materials with more advantageous mechanical properties for particular applications of the device. For example, in applications where the first element 110 (FIG. 1) is exposed to adverse and/or extreme environmental conditions, the material for the first element may be selected as having desirable mechanical characteristics best suited to the conditions where the device will be used. One preferred combination is as follows;

| | |
|---|---|
| First Element Material | Gallium Arsenide (GaAs) |
| Second Element Material | Diamond (C) |
| Third Element Material | IG2 |

GaAs is a physically resilient material and as such would be particularly useful as an external element. Other possible combinations for first/third element materials to be used in conjunction with a diamond second element material include, but are not limited to, GaAs/ZnSe, ZnSe/GaAs, ZnSe/[IR Chalcogenide], ZnS/GaAs, ZnS/[IR Chalcogenide], and ZnS/ZnSe. It should be noted there are several IR Chalcogenides that may be suitable.

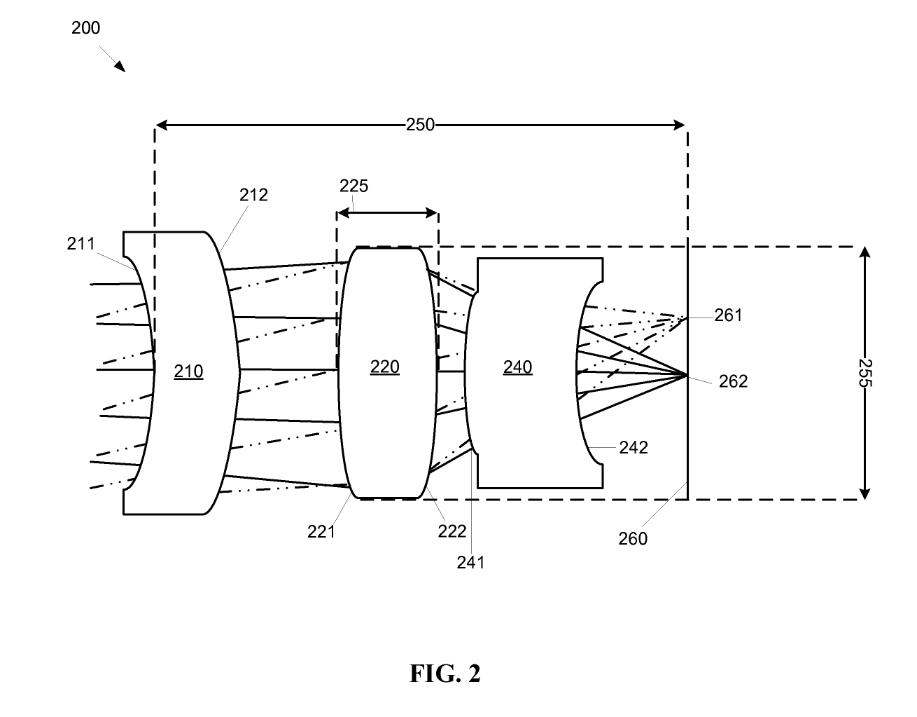

An example of the layout which employs this particular material combination is shown in FIG. 2. FIG. 2 shows a more detailed drawing than FIG. 1 of the first embodiment. The optical device 200 includes a first element 210, a second element 220, and a third element 240. Incident radiation enters the device 200 through an ingress surface 211 of the first element 210. The ingress radiation may include many wavelengths originating from a single object in the scene which the objective is looking at. For simplicity, FIG. 2 shows a first field angle shown as a dash-dot-dot line and a second field angle, shown as a solid line. The radiation from these field angles, in both wavebands of interest, enters the first element 210 and is then focused onto a single focal plane 260. The ingress radiation exits the first element 210 through an egress surface 212, and travels through an intermediate media, for example, air or a vacuum, to an ingress surface 221 of the second element 220. The radiation then enters the second element 220 via the second element ingress surface 221, and exits the second element 220 via the second element egress surface 222.

Upon exiting the second element 220, the radiation is directed through a medium between the second element 220 and the third element 240, for example, air or vacuum. The radiation then enters an ingress surface 241 of the third element 240, and exits the third element 240 via an egress surface 242, directed toward a focal plane 260. The focal plane 260 may coincide with, for example, an image sensing surface or detector.

Ideally the focus on the focal plane 260 will be at the same image height on the detector for both wavebands, although the distortion and/or focal length may vary slightly between wavebands which would cause the focus to be at slightly different image heights. Preferably, this would be minimized by the system designer.

Under the first embodiment, the first element ingress surface 211 may be a concave aspherical surface, while the first element egress surface 212 may be a convex aspherical surface. The diamond second element ingress surface 221 may be a convex spherical surface, and the second element egress surface 222 may also be a convex spherical surface. The third element ingress surface 241 may be a convex aspherical surface, while the third element egress surface 242 may be a concave aspherical surface.

As used within this disclosure, persons having ordinary skill in the art will realize that the terms “convex” and “concave” can be ambiguous with the use of aspheres. For example with the layout presented in FIG. 2, the external surface 211 (ingress surface of the front element) will “want” to be concave for aberration correction. The edge of the surface is projected slightly outward of the center of the surface and the underlying base curvature is such that if the aspheric terms were removed the surface would still curve in that direction. However it may be desirable to force the underlying curvature to curve in the opposite direction while the aspheric terms compensate and keep the edge of the surface projected slightly outward of the center. In these circumstances, the surface would still look concave, but the initial direction of curvature (and underlying base curvature) would imply that the surface is convex. This can be further complicated by forcing the edge to fall below the center of the surface. In such an instance, the edge of the lens still curves outwards, but does not become projected slightly outward of the center of the surface. In forcing this situation the correction of the system is compromised to a degree. This correction can be regained by the inclusion of an asphere on one of the diamond surfaces.

Practically, a stop may be placed on (or near to) the diamond element(s) to minimize their size. Preferably an asphere may be included on the surface closest to the stop as it is best placed to correct pupil dependent aberrations. However, practical considerations make it difficult to create even spherical lenses in diamond, so it may be desirable to avoid the use of aspheres on diamond. Accordingly, other lens configurations are possible, for example, changing the curvature of a lens from aspheric to plano, subject to the resulting effects described above, among others.

The combination of characteristics of the element 210, 220, 240 materials and the lens shape of the first, second and third elements 210, 220, 240 results in directing radiation of different object angles to different portions of the focal plane 260. For example, as shown by FIG. 2, the first field angle shown as a dash-dot-dot line is generally directed toward a first portion 261 of the focal plane 260, and the second field angle, shown as a solid line is generally directed toward a second portion 262 of the focal plane 260. Both wavebands will be focused at any given image height. While the focal plane 260 is depicted as a flat planar surface, in alternative embodiments the focal plane 260 may not be planar, but instead have a different topography, for example, but not limited to, a concave or convex spherical surface, or a concave or convex aspherical surface.

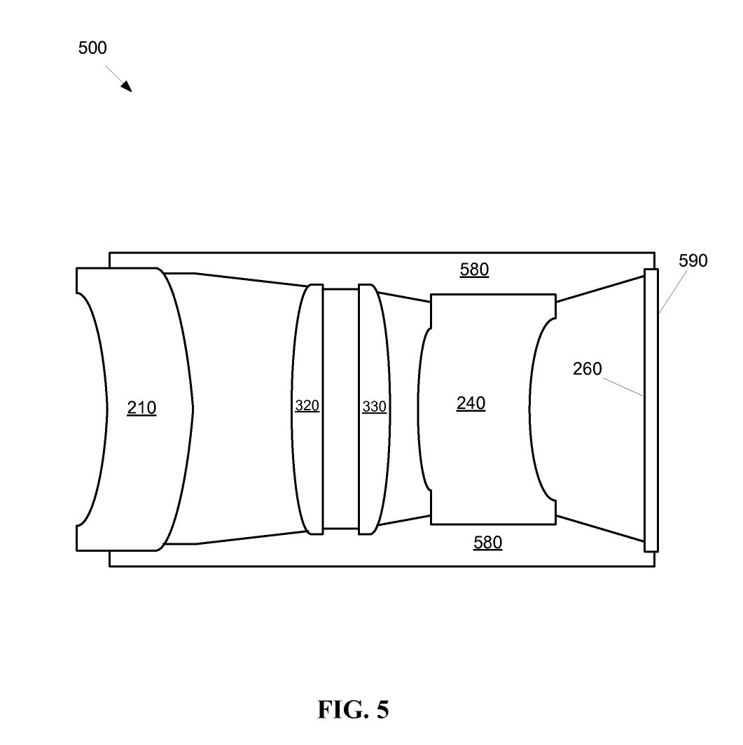

The first element 210, the second element 220, and the third element 240 may be mounted within a housing 580 (FIG. 5) to maintain their positions relative to one another, and to prevent particles and debris between the elements 210, 220, 240 and the focal plane 260. The geometry of the elements impacts the radiation paths, as is familiar to persons having ordinary skill in the art. For example, the distance 250 between the first element ingress surface and the focal plane 260, the distance 225 between the second element ingress surface 221 and the second element egress surface 222, and the diameter 255 of the second element, may be adjusted according to the specific configuration needs of the implementation.

In addition, the spacing between the first, second, and third elements 210, 220, 240 may also factor into the focal positions of different field angles on the focal plane 260. The layout can be thought of from first principles. As mentioned previously, for thin elements (lenses) in contact at the stop, the chromatic properties of two of the three materials combine to form an imaginary material with dispersion characteristics which complement the third material. This principle holds true for the layouts described. Some exemplary system parameters are shown for three different detector resolution and pixel pitch configurations in the table 1 below.

TABLE 1

| | (640 × 480) | (320 × 240) | (320 × 240) |
|---|---|---|---|
| | 12 μm | 25 μm | 20 μm |
| F# | 1.2 | | |
| EFL | 10.81 | | |
| OAL | 24.1 | | |
| Semi VFOV | 15.1 | 15.8 | 12.7 |
| Semi HFOV | 20 | 20.8 | 16.8 |
| Semi CFOV | 24.7 | 25.6 | 20.8 |

In TABLE 1, EFL is the effective focal length in mm, OAL is the overall length in mm, VFOV is the vertical field of view, HFOV is the horizontal field of view in degrees, and CFOV is the corner field of view of the detector in degrees.

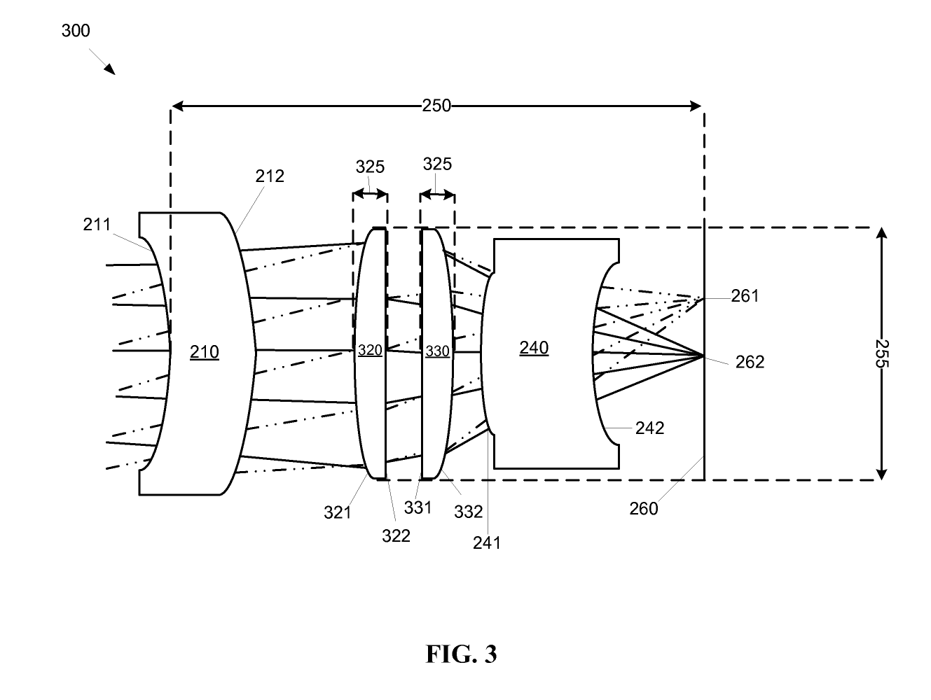

FIG. 3 shows a second embodiment of an optical system. The second embodiment is substantially similar to the first embodiment, where the one piece second element 220 (FIG. 2) of the first embodiment is replaced by a two-piece second element 320, 330, including an ingress piece 320 and an egress piece 330. The pieces 320, 330 of the two piece second element may be substantially similar, where they both have the same diameter 255, and the same thickness 325. The ingress piece ingress surface 321 may be substantially similar to the ingress surface 221 (FIG. 2) of the first embodiment, and the egress piece egress surface 332 may be substantially similar to the egress surface 222 (FIG. 2) of the first embodiment. An egress surface 322 of the ingress piece 320 may be substantially planar. Similarly, an ingress surface 331 of the egress piece 330 may be substantially planar. The two-piece second element 320, 330 may be functionally similar to the one-piece second element 220 (FIG. 2) of the first embodiment, but may be preferable for manufacturing purposes. For example, the diamond material used for the second elements 220 (FIG. 2), 320, 330 is relatively expensive, and a two piece second element 320, 330 may use less diamond material than a one-piece second element 220 (FIG. 2). In addition, the manufacturing of a two piece second element 320, 330 where each piece has one planar surface 322, 331 may be easier to manufacture than a one-piece second element 220 (FIG. 2) having two spherical surfaces 221, 222.

Under the second embodiment 300, the distance 250 between the first element ingress surface and the focal plane 260 may be approximately 24.1 mm, and the thickness 325 of each piece 320, 330 of the two piece second element may be approximately 1.5 mm, where of each piece 320, 330 of the two piece second element both have the same diameter 255, of approximately 13.0 mm. Of course, the second embodiment is not limited to these dimensions, and other dimensions are possible.

FIG. 5 is a cutaway schematic diagram of the second embodiment optical device in an exemplary housing 580. The housing 580 may have a substantially cylindrical exterior, with the interior configured to secure the elements 210, 320, 330, 240 within the housing 580. The elements 210, 320, 330, 240 may be affixed directly to the housing 580, or may be secured to the housing 580, for example, with padding and spacers and the like. The housing 580 may be one-piece, as shown, or may include multiple components attached together. The focal plane 260 may be the surface of an optical sensor 590.

The material used for the housing 580 is preferably relatively light, strong and chemically stable. For example, the housing 580 may be formed of aluminum. The grade of aluminum used may vary slightly depending on the application. Other housing materials may provide different benefits. For example, some materials may be lighter, some may be stronger, and others may have more beneficial coefficients of thermal expansion (CTE). As noted previously, aₕ in FIGS. 4A and 4B indicates the coefficient of thermal expansion of a material housing the elements. The use of a different housing material may eliminate the need for thermal spacers to achieve athermal performance.

The overall size and form of the device 500 may be similar to that of a conventional situational awareness or goggle objective which works in only one waveband. However, the use of diamond material for the second (central) element 320, 330 allows the imaging capability to be extended to a second waveband.

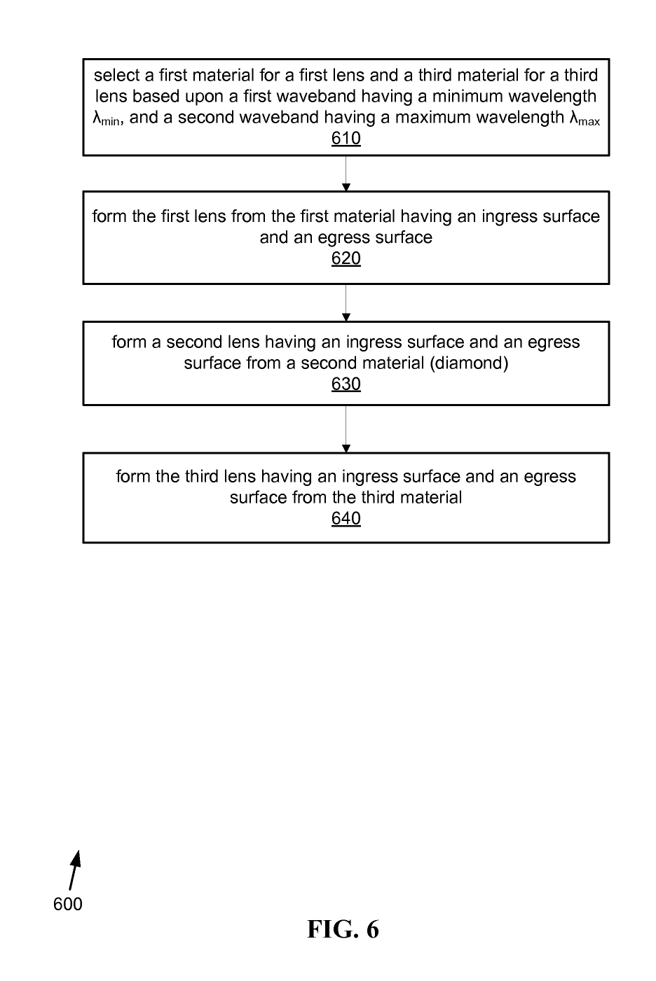

An exemplary method 600 for forming a multispectral wide angle refractive optical device is shown in FIG. 6. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A first material is selected for a first lens 110 (FIG. 1) and a third material is selected for a third lens 140 (FIG. 1) based upon a first waveband having a minimum wavelength λₘᵢₙ, and a second waveband having a maximum wavelength λₘₐₓ, as shown by block 610. The first lens 110 (FIG. 1) is formed from the first material having an ingress surface and an aspherical egress surface, as shown by block 620, for example, an aspherical ingress surface. A second lens 120 (FIG. 1) having an ingress surface and an egress surface is formed from a second material (diamond), as shown by block 630, for example, a spherical ingress surface and a spherical egress surface. The third lens 140 (FIG. 1) is formed from the third material having an ingress surface and an egress surface, as shown by block 640, for example, an aspherical ingress surface and an aspherical egress surface.

Among other advantages of the above embodiments, there is a potential for significant mass reduction compared with previous systems for resolving multiple wavebands. This presents the significant challenge of achieving color correction across two wavebands simultaneously in a wide angle system.

While diamond lenses have been produced previously which would be similar in form and size to those in the above embodiments, the use of diamond lenses as the central component of an optical scheme which allows WFOV imaging of multiple wavebands onto a common focal plane is new. The central diamond component(s) allow the chromatic correction for the two wavebands. Materials 1 and 3 can be changed for other materials which transmit in both the SWIR and the LWIR provided that they lend themselves to the manufacture of aspherical surfaces.

Depending on considerations such as material selection for exposed portions of the system and selection of internal materials such as lenses and/or spacers, the design of the system can be made slightly more or less athermal. With proper housing/spacer material selection the design may be made passively mechanically athermal, allowing the optical performance to be maintained across a large temperature range.

While an exemplary objective for the above embodiments includes usage in goggles, persons having ordinary skill in the art will recognize the principles may be applied for other applications, for example, situational awareness objectives and Drivers Vision Enhancement (DVE) objectives.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A refractive multispectral wide angle refractive optical device for focusing light from a first waveband having a minimum wavelength λₘᵢₙ, and a non-overlapping second waveband having a maximum wavelength λₘₐₓ, comprising:
a first element formed of a first material comprising an ingress surface, configured to receive incident radiation, and an egress surface;
a second element formed of a second material comprising an egress surface and an ingress surface configured to receive radiation from the egress surface of the first element;
a third element formed of a third material comprising an egress surface and an ingress surface configured to receive radiation from the egress surface of the second element;
a shared optical train for the first waveband and a second waveband; and
a common focal plane for the first waveband and a second waveband,
wherein the second material comprises diamond, and the first material, second material, and third material are different materials.

2. The device of claim 1, wherein:
the first element ingress surface is aspherical;
the first element egress surface is aspherical;
the third element ingress surface is aspherical; and
the third element egress surface is aspherical.

3. The device of claim 1, wherein the second element ingress surface is spherical and/or the second element egress surface is spherical.

4. The device of claim 1, wherein at least one of the second element ingress surface and the second element egress surface is aspherical.

5. The device of claim 1, further comprising a housing configured to mount the first element, the second element, and the third element.

6. The device of claim 5, wherein the housing provides a first gap between the first element and the second element, and a second gap between the second lens and the third lens.

7. The device of claim 1, wherein pairings for the first material and third material comprise one of the group of material pairings including GaAs/infrared Chalcogenide glass (IR Chalcogenide), GaAs/ZnSe, ZnSe/GaAs, ZnSe/IR Chalcogenide, ZnS/GaAs, ZnS/IR Chalcogenide, and ZnS/ZnSe.

8. The device of claim 6, wherein a media in the first gap and/or the second gap comprises air.

9. The device of claim 1, wherein the chromatic properties of two of the group consisting of the first material, the second material, and the third material combine to form an imaginary material with dispersion characteristics, which complement the remaining material of the group.

10. The device of claim 1, wherein the first waveband and the second waveband are not contiguous.

11. The device of claim 1, wherein the second element is a compound element comprising a first piece and a second piece.

12. A method for forming a multispectral wide angle refractive optical device for focusing light from a first waveband comprising a minimum wavelength λₘᵢₙ, and a second waveband comprising a maximum wavelength λₘₐₓ on a common focal plane, comprising the steps of:
selecting a first material for a first lens and selecting a third material for a third lens based upon λₘᵢₙ and λₘₐₓ;
forming the first lens from the first material comprising an ingress surface and an egress surface;
forming a second lens comprising an ingress surface and an egress surface from a second material; and
forming the third lens comprising an ingress surface and an egress surface from the third material,
wherein λₘᵢₙ is less than λₘₐₓ, and the second material comprises diamond, and the first and third material are selected to, along with the second material, focus the first and the second waveband on a common focal plane.

13. The method of claim 12, wherein the first lens ingress surface and/or the third lens ingress surface comprises an aspherical ingress surface, and the first lens egress surface and/or the second lens egress surface comprises an aspherical egress surface.

14. The method of claim 12, wherein the second lens ingress surface is spherical and/or the second lens egress surface is spherical.

15. The method of claim 12, wherein said selecting the first and/or third material further comprises determining an Abbe number V with the equation
$$V = ( \frac{{n}_{λ , mid} - 1}{{n}_{λ , min} - {n}_{λ , max}} )$$
wherein n_{λ,mid} is a refractive index of the material at a harmonic mean λ_{mid} of λₘᵢₙ and n_{λ,min} is a refractive index of the material at λₘᵢₙ, and n_{λ,max} is a refractive index of the material at λₘₐₓ.

16. The method of claim 15, wherein said selecting the first and/or third material further comprises determining a partial dispersion of the material between a wavelength λ and λₘᵢₙ with the equation
$${P}_{λ} = ( \frac{{n}_{λ , min} - {n}_{λ}}{{n}_{λ , min} - {n}_{λ , max}} ) .$$

17. The method of claim 12, wherein the first waveband comprises a short wave infrared waveband, and the second waveband comprises a long wave infrared waveband.

18. The method of claim 12, wherein pairings for the first material and third material comprise one of the group of material pairings including GaAs/infrared Chalcogenide glass (IR Chalcogenide), GaAs/ZnSe, ZnSe/GaAs, ZnSe/IR Chalcogenide, ZnS/GaAs, ZnS/IR Chalcogenide, and ZnS/ZnSe.

19. The method of claim 12, wherein the first waveband and the second waveband are not contiguous.

20. A refractive multispectral wide angle refractive optical device for focusing light from a first waveband having a minimum wavelength λₘᵢₙ, and a non-overlapping second waveband having a maximum wavelength λₘₐₓ, comprising:
a first lens formed of a first material comprising an ingress surface configured to receive incident radiation and an egress surface;
a two piece second lens formed of a second material comprising a first piece comprising an ingress surface configured to receive radiation from the egress surface of the first lens and an egress surface, and a second piece comprising an ingress surface and an egress surface;
a third lens formed of a third material comprising an ingress surface configured to receive radiation from the egress surface of the second lens second piece and an egress surface;
a shared optical train for the first waveband and a second waveband; and
a common focal plane for the first waveband and a second waveband,
wherein the second material comprises diamond, and the first material, second material, and third material are different materials.

21. The device of claim 20, wherein:
the first element ingress surface is aspherical;
the first element egress surface is aspherical;
the third element ingress surface is aspherical; and
the third element egress surface is aspherical.

22. The device of claim 20, wherein:
the second element first piece egress surface is planar; and
the second element second piece ingress surface is planar.

23. The device of claim 22, wherein at least one of the second element first piece ingress surface and the second element second piece egress surface is aspherical.

24. The device of claim 22, wherein:
the second element first piece ingress surface is spherical; and
the second element second piece egress surface is spherical.

25. The device of claim 20, further comprising a housing configured to mount the first element, the second element, and the third element.

26. The device of claim 25, wherein the housing provides a first gap between the first element and the second element, and a second gap between the second element and the third element.

27. The device of claim 26, wherein the housing provides a third gap between the second element first piece and second piece.

28. The device of claim 20, wherein pairings for the first material and third material comprise one of the group of material pairings including GaAs/infrared Chalcogenide glass (IR Chalcogenide), GaAs/ZnSe, ZnSe/GaAs, ZnSe/IR Chalcogenide, ZnS/GaAs, ZnS/IR Chalcogenide, and ZnS/ZnSe.
